(19) United States
(12) Patent Application Publication
(10) Pub. No.: US 2025/0328151 A1
(43) Pub. Date: Oct. 23, 2025

(54) Robotic System With High Intelligence And High Security To Detect A Wide Range Of Crimes

(71) Applicants: Ching-Tien Ho, San Jose, CA (US); Theodore Lee, San Jose, CA (US); Chi Ho Wong, Foster City, CA (US); Raymond Liu, Seattle, CA (US)

(72) Inventors: Ching-Tien Ho, San Jose, CA (US); Theodore Lee, San Jose, CA (US); Chi Ho Wong, Foster City, CA (US); Raymond Liu, Seattle, CA (US)

(21) Appl. No.: 19/060,805

(22) Filed: Feb. 24, 2025

Related U.S. Application Data
(60) Provisional application No. 63/559,219, filed on Feb. 29, 2024.

(51) Int. Cl. G05D 1/656; G05D 1/69; G05D 101/15; G05D 105/85; G05D 109/10

(52) U.S. Cl. CPC G05D 1/656; G05D 1/69; G05D 2101/15; G05D 2105/85; G05D 2109/10

(57) ABSTRACT

A Crime Detection robotic System is provided to detect a wide range of crimes through four functions: the pre-processing function, the evaluation function, the decision-making function, and the key manager function. The crime detection system accomplishes the mission either by a single robot or by a group of robots, which is determined and managed by the key manager function. The crime detection mission can be pre-determined and stored in the system library. A new crime detection mission can be newly created by software and a new set of keys. The key manager along with the three other functions can dynamically re-define and re-assign a single or multiple robots for a single or multiple crime detection missions on the same robotic platform leading to a cost-effective method for a wide range of crimes.

This application claims the benefit of U.S. Provisional Application No. 63/559,219 filed on Feb. 29, 2024.

### TECHNICAL FIELD

Embodiments of the invention related to a collection of security methods for intelligent robotic systems for crime detection.

### BACKGROUND

Robotic systems are rapidly adopted for an increasing range of tasks from manufacturing, patrolling, mission-critical assignment, to commercial and military applications. These robots are equipped with more computing devices, sensors and communication connections. The more integrated robots are with sensitive tasks and with their users' lives, the greater desirability they possess as targets to attackers.

Much like regular computers, robots can be targeted by numerous security attacks with all sorts of malicious goals. Current robots are subject to security attacks and are fragile. Security has not yet been a major focus within robotic systems and there is a lack of security architecture defined for the robotic systems. Techniques based on KEY MANAGER are provided to enhance the security of a robotic system.

Besides the lack of security, the market demands the improvement of the intelligence of robotic systems. Al-based techniques are being adopted to increase the intelligence of a robotic system. The Al-based system consumes huge amounts of data for training and for deployment. Unfortunately, the robotic system uses a resource-constrained hardware platform with a limited amount of storage and memory. How to use a simple, common robot platform to address a wide range of applications cost-effectively is essential to drive the market acceptance of Al-based intelligent robotic systems. This invention uses four functional blocks (the preprocessing function, the evaluation function, the decision-making function and the key manager function) to increase the intelligence level of robotic systems and to address a wide range of crime detection tasks cost-effectively.

### SUMMARY

This invention solves a set of security problems for robotic systems in general and for a crime-detection robotic system as an embodiment. These security solutions form a security architecture and are collectively called KEY MANAGER because the security solutions are all related to secret keys assigned to a robot.

The crime detection robotic system is used as an embodiment of the invention. The four functions of the crime detection robotic system (the preprocessing function, the evaluation function, the decision-making function and the key manager function) are used to characterize the key elements of the embodiment. The invention can be applicable to other embodiments carrying similar functions.

The evaluating function relies on a pre-trained model M2 that is derived from a multimodal LLM (Large Language Model) M1, which can be one of the many multimodal LLMs publicly available through subscription fee. Examples of these LLMs include, but are not limited to, OpenAI GPTs (e.g., GPT 3, GPT 3.5, GPT 4), Meta Llama/Llama 2, Google Bard/Gemini, etc. The embodiment pre-trains model M2 from M1 specialized in the domain of crime detection. Similarly, the evaluating function is specialized in the context of the crime detection robots.

The derivation of the pre-trained model M2 from M1 relies on a combination of the steps below.
1. Training Data Collections
Many third party multimodal LLMs can generate images from text. These models can be used to generate many security threats related images for the training. These are called text-to-image generative AI models. Examples include OpenAI Sora, Midjourney, DALL-E 3, Stable Diffusion, Imagen, Muse, DreamBooth, DreamFusion, GLIGEN, pix2pix-zero. These images are labeled and used to train M1 towards M2 using Step 3 to be described later.
2. Training Data Labeling
Many of the generated images will fit the threat event criteria. For example, if the text input is “an emerging crowd with some holding weapons,” the generated images will likely show as intended. However, some manual corrections are needed. Further, for a better follow-up action, it is desired to identify the type or category of the threat that the image belongs to.
3. Using Deep Learning through Data Collection and Data Labeling Stage
   a. In general, the embodiment gradually builds up layer by layer, similar to the deep learning technique, relevant objects or primitive functions.
   b. For example, a very bottom layer can be the detection of any foreground objects such as an animal, a person, or an object that could be held by hands, etc.
   c. The second layer can determine the type of hand-held objects, and the type of person identified (based on clothing, perceived age, body size, etc.).
   d. The third layer can determine if the combination of person type and hand-held object type constitute a threat.
   e. It may have constituted a trespassing private property violation event, but not yet triggered a real threat event depending on the customizable type/category definitions
4. Teaching Multimodal LLM Model M1 to become M2
Techniques below are used in this step
   a. Prompt engineering
   b. Reinforcement learning
   c. Calling third-party special classifiers through GPT Assistant API (for external function calls)
5. Adding an internal classification model before calling GPT.
Having a classifier before the call to GPT can be used as optimization to remove much unnecessary checking such as no interesting audio detection beyond typical surrounding noises or no interesting video movement detection beyond subtle background changes (e.g., tree leaves moved by wind).
6. Adding an internal classification model after calling GPT.
Having a classifier after the call to GPT can be used to customize special events that are normal for specific customers. For example, the customer may have contracted deliveries for different purposes. During the initial deployment stage, the customer can fine tune certain detected events as non-threats based on customer knowledge.
7. Use edge processors in the Electric Vehicle
Once the pre-model M2 is finalized and enhanced with a pre-classifier C1 (described in Step 5) and a post-classifier C2 (described in Step 6), the evaluating function of the Crime Detection Robotic System will be deployed as a model consisting of C1+M2+C2 running on one or multiple edge processors in the robotic system locally.
8. Add a traditional gas engine to conserve battery running time
To save electricity (and prolong battery run time) required by running the electric vehicle (EV) on which the Crime Detection Robotic System is embedded, a traditional gas engine can be added to the EV so as to conserve electricity for a much longer battery run time.

The invention also solves several problems related to cyberattacks on general computing platforms, general robotics platforms and more specifically the crime detection robotic system.

As described, in existing robotic systems there is a lack of security and intelligence. This invention employs a KEY MANAGER function (along with three other functional blocks) to enhance security of general robotic systems and specifically for a class of crime-detection intelligent robotic systems empowered by artificial intelligence (AI) techniques. The KEY MANAGER consists of several features and security mechanisms to be described in the drawing and the description of the drawing below.

These security and AI features and mechanisms in the invention improve the security level and intelligence level of robotic systems and solve the problems listed below.
1. Secret keys are assigned to a robot as the identity (ID) for security-related purposes. The ID is used to authenticate the robot to participate in the crime-detection mission. Any robot without a valid matching ID is excluded from the mission.
2. In a mission that requires a group of collaborating robots, the keys are used to commission and coordinate the robot group. With the keys, the robots in the group are allowed to communicate and share information with other robots in the same group. Robots belonging to different key groups are not allowed to communicate and share information. Subject to the mission, grouping of robots is dynamic because the keys can be assigned dynamically. This has an advantage in security and cost.
3. The keys along with a set of cryptography algorithms are used in inter-robot communication. With the cryptography algorithms, secret keys are never released to the outside world. Rather, aliases of keys are used in inter-robotic communication. An attacker cannot decipher the secret keys from wired or wireless communication channels.
4. The keys are used to define the crimes through software, hence, a common robot hardware platform can detect a wide range of crimes, which leads to a cost-effective implementation. Furthermore, the keys are integrated with the LLM and three other functional blocks such that a specific robot can acquire knowledge through a focused knowledge area. This specific robot with a specific key can learn a specific area deeply and quickly with a reduced memory/storage requirement.
5. The KEY MANAGER protects the robot from attacks from quantum computers by running a set of post-quantum cryptography algorithms. The algorithms are further accelerated by a set of post-quantum cryptography engines to deliver a high-performance, cost-effective robotic system.
6. The KEY MANAGER monitors the entire robot group constantly. It can disable a robot that is suspected of being attacked (an infected robot) by revoking the keys assigned to the specific robot. In a group of collaborating robots, the KEY MANAGER revokes the keys from a misbehaving robot to ensure the mission of the group can be executed successfully.

### BRIEF DESCRIPTION OF THE DRAWINGS

The present invention is illustrated by way of example, and not by way of limitation, in the figures of the accompanying drawings. The applicability can be extended to other intelligent embodiments with functions similar to the above- mentioned four.

FIG. 1 depicts four functional blocks of the Robotic Crime Detection System consisting of four core functions of the embodiment:
preprocessing function,
evaluation function,
decision-making function and
key manager function; and

FIG. 2 is the next-level illustration of KEY MANAGER detailing the functions of the Key Manager. It consists of 11 functional sub-blocks while two sub-blocks (410 and 411) are tightly integrated with the three other functional blocks.

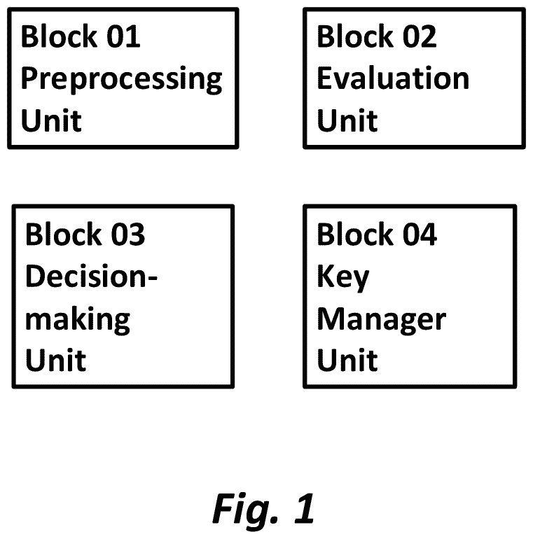

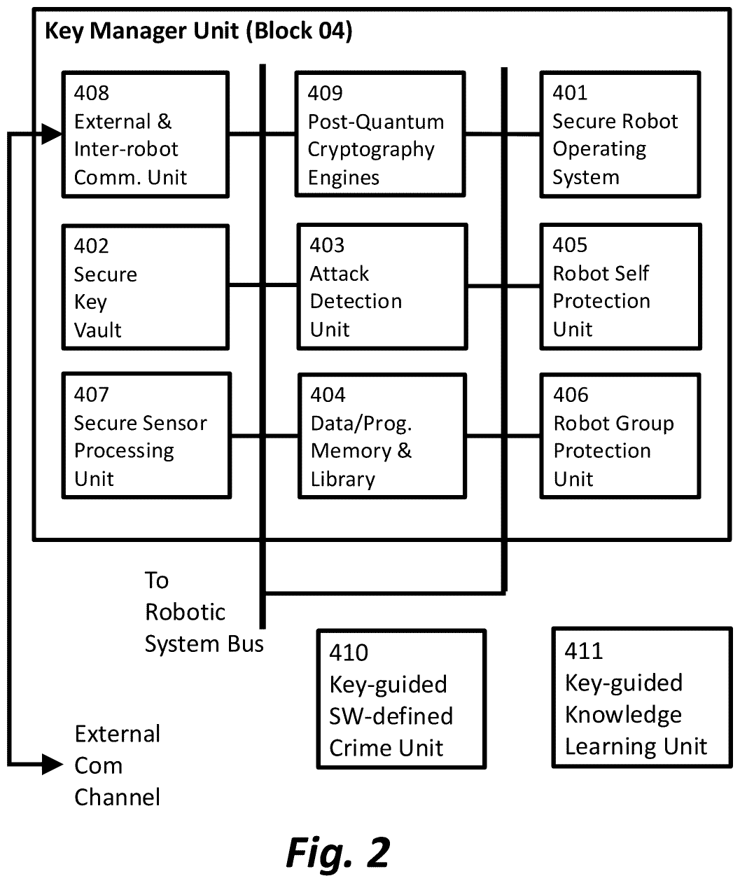

### DETAILED DESCRIPTIONS

The Key Manger block (Block #4) in FIG. 1 consists of 11 sub-blocks. The functions of these sub-blocks are described below.

### Block 401: Secure Robot Operating System (SROS)

SROS manages the boot of the robot, uses the keys to control robots' access to memory, and is responsible for coordinating the sub-blocks and the interaction with the three other functional blocks.

SROS uses a small secure kernel (about the size of 10 KB) as the base. It has its own data memory and program memory. The address space of these data memory and program memory belongs solely to SROS so that no other functional blocks or sub-blocks of a robot can access these memory locations. This forms a solid foundation of robotic security.

At power-on, SROS sets up the “right to access” different segments of memory to each block and sub-blocks. This includes
the right to access the Key Vault (block 402) where all secret keys are stored,
the right to access Attack Detection Unit (block 403),
the right to access mailboxes in the External and Inter-robot Communication Unit (block 408),
right to access Robot Self-Protection Unit (Block 405),
right to access Robot Group-Protection Unit (Block 406), and
general data memory, program memory and library memory (Block 404).

The “right to access” is based on keys for each individual robot and the keys for each collaborating robot group. The key-based “right-to-access” highly restricts the behavior of each functional block and sub-block, and highly isolates a robot from other robots except when they are assigned to collaborate,

### Block 402: Key Vault

The Key Vault is a dedicated, secure, non-volatile memory that stores sensitive data such as:
key (identity) for each individual robot,
keys for each collaborating group of robots,
keys to enable the definition of a new crime through software,
keys for the focused knowledge areas for knowledge learning,
keys to protect a maintenance port of a robot,
cryptographic keys to run post-quantum algorithms and resist PQ attacks, and
other keys as needed.

The “right to access” Key Vault is set up at boot time by SROS. Only SROS is allowed to access Key Vault. Illegal access to Key Vault will be rejected, recorded and reported to SROS.

As the mission of a robot changes and since a robot may not be suitable to perform a specific mission based on its current keys, the keys of a robot may need to be changed. Block 402 and Block 401 jointly manage the lifecycle of the keys including initiating, updating, revoking, and transferring.

### Block 403: Attack Detection Unit (ADU)

The ADU uses the keys (and associated logic) to detect illegal access to memory. For example, a robot with key “X” attempts to access memory segments that are not permitted by using key “X”. The ADU builds logic associated with memory to determine a match between the key and attempted memory access. When the key does not match, a signal is generated to reject the access, and the attempted access is reported to SROS. The ADU can detect the attacks from side-channels including power attack, electrical-magnetic attack, and fault injection attacks.

Block 404: Data memory, program memory and library

This is the area to store data, code, and crime software libraries for individual robot or collaborating robot groups. The memory is segregated into segments by keys. Only the robot with the matching key is allowed to access the proper segment of the memory.

### Block 405: Robot Self Protection Unit (RSPU)

Existing robots have “maintenance ports” for a technician to update, upgrade or repair the robot through software. This port is also used for debugging if there is any malfunction of a robot. Being unprotected, this “maintenance port” becomes a “security hole” to be attacked. Through this port, much information about the robot can be accessed, stolen or modified. Special keys are used to protect the port to prevent unauthorized parties from accessing the robot physically or remotely. Special keys and algorithms are also used when upgrading the software of the robot through this port. For the very sensitive RSOS, the firmware update for SROS needs to go through this port with protected keys and algorithms.

### Block 406: Robot Group Protection Unit (RGPU)

Similar to the Robot Self Protection Unit, another set of keys are given to each collaborating group of robots. Only the robots with the matching keys are given the “right of access” to the proper memory segments. Illegal accessing is rejected and is reported to SROS for proper handling. The management of the robot group is dynamic; therefore, the mission of the robot group can be dynamically allocated using the same robot hardware platform. This is a cost effect method to handle a wide range of missions.

### Block 407: Secure Sensor Protection Unit (SSPU)

Robots are equipped with a set of sensors to detect and collect information from the environment. These sensors are subject to security attacks (for example, by providing robot inconsistent information). SSPU uses redundant sensors to decide if the sensed data are trustable. When the robot is attacked through sensors, the collected data from the redundant channels will be inconsistent. SSPU will detect the inconsistency and report to SROS for proper handling.

### Block 408: External and Inter-robot Communication Unit (EICU)

EICU is responsible for secure communication with the external world and secure communication/collaboration among the collaborating robots. EICU uses a set of secure mailboxes for such communications. Each mailbox is protected by a key. Only the robot with the matching key is allowed to use the specific mailbox for either external communication or communication with a specific robot group. All communications through mailboxes are securely encrypted and integrity protected using the matching keys.

### Block 409: Post-Quantum Cryptography Engines (PQCE)

PQCE is a collection of hardware and software to execute a set of post-quantum cryptography algorithms efficiently. The PQC algorithms contain encryption, decryption, digital signature, hashing and key exchange. Depending on the required/desired security level and performance level, specific algorithms can be selected and matching hardware accelerators can also be selected to protect the robot.

### Block 410: Key-guided Software-defined Crime Unit

This sub-block performs three functions:
(a) It uses the identification (ID) of a robot to select a set of crimes (and their associated codes) to support the missions to be performed by the robot.
(b) When a robot is participating in detecting certain crimes as a group, this unit uses the group key to select a set of crimes (and their associated codes) for the robot to perform the mission and to communicate with other robots in the same group.
(c) If a crime (and the associated elements in the crime database) does not exist, this unit uses the key(s) to create a new crime (and the associated crime elements in the crime database) such that the new crime can be defined and the associated database can be generated. The new crime is then added to the crime library.

This unit passes the keys to the other functional blocks, and interacts with the other three functional blocks to accomplish function (a), (b) and (c) of this block.

Block 411: Key-guided knowledge Learning Unit

This unit interacts with other three functional blocks and LLM, and uses the keys to guide the knowledge learning of a robot. The unit passes the keys to the other functional blocks to guide the robot to explore certain focused areas of the knowledge learning database in a prioritized manner. The unit uses the keys to enable a robot to learn a prioritized area faster and deeper. It is also a method for the unit to customize a robot for selected crimes. The capability of using the keys to guide the learning enables the use of a common robotic platform to address a wide range of applications cost-effectively.

1. A robotic system comprising at least one robot or multiple robots, wherein each of the robot is equipped with an intelligent and secure “Crime Detection System (CDS)” to detect the crimes by individual robot or by a group of collaborating robots; wherein
the CDS is based on LLM (Large Language Model) and is enhanced by four (4) functional blocks
(a preprocessing function, an evaluation function, a decision-making function and
a key manager function) configured to take audio, video and a set of secret keys as
inputs besides texts; and
wherein the four functional blocks, along with LLM are configured to:
(a) select one robot or a group of collaborating robots to detect the crime or crimes;
(b) define each crime or group of crimes based on a software under a guidance of the keys;
(c) control the crime definition and its associated knowledge learning by the keys;
(d) control selection of robot(s) by the keys; and
(e) allow the robots belonging to the same key group to communicate, share information and collaborate to detect the crime(s); while the robots having different keys are prohibited to communicate, share or collaborate.

2. The robotic system as in claim 1 wherein a crime detected by CDS is categorized by:
one of the enumeration below:
assault, loitering, harassment, burglary, vandalism, baby crying, gas leakage,
health emergency, and large scale of mob rioting. Suspicious crime elements may include
unusual sounds such as sirens, gunshots, alarms, humans shouting/screams, baby crying,
explosions, unidentified drone/aircraft low-altitude, and hovering sounds. Other crime indicators
may include house door ajar for a long period of time, a vehicle without a license plate, a parked
vehicle with a headlight or emergency light on, people wandering in a restricted area, sharp
sounds (i.e. a sudden and loud sound, a crashing sound in a quiet office area, and suspicious
crimes related unique objects (such as knives, long clubs, guns), a large crowd of people, a
ghetto blaster boombox with loud music, a large package in a parking lot, any item with
protruding wires, antenna or clock, a broken window or door, and an object or vehicle blocking a
major road crossing); or
one defined by the CDS based on software and keys.

1. DS as in claim 1 configured to build unique intelligence and security on top of LLM by four (4) functional blocks:
(a) a Preprocessing Function block that performs preprocessing function,
(b) an Evaluating Function block that performs evaluating function,
(c) a Decision-making Function block that performs decision-making function, and
(d) a Key Manager block that performs key manager function.

3. DS as in claim 3 wherein the Preprocessing Function block preprocesses captured input data performing processes comprising:
a) removing noises from visual and audio input to enhance signal clarity using filters;
b) dividing video footage into individual frames for easier processing of images i) to identify specific objects in each frame, and ii) to separate foreground from background to prepare for Object Recognition, Motion Tracking, and Activity Recognition;
c) determining the captured object in each single frame using Object Recognition technique (e.g. recognizing an object is a car, or a tree, etc.) by the LLM model;
d) extracting and processing specific sound using Signal Processing and Feature Extraction techniques, such as Mel-Frequency Cepstral Coefficients (MFCCs);
e) feeding the extracted sound into a machine learning model (e.g., the CDS Matrix System) to understand its meaning; and
f) forwarding all processed data to the Evaluating Function block.

3. The CDS as in claim 3 wherein the Evaluating Function block combines different types of data inputs to evaluate and cross-check both sound and image data simultaneously performing processes comprising:
integrating and synchronizing multiple different types of data, such as auditory (sound) and visual (images) cues using deep learning models to gain understanding of specific patterns of complex, real-world crime activities and to reduce false-positives;
sending a To-Go signal to the Security Robot when the activities meet the internal evaluating threshold; and
sending an alert to a Human Supervisor located in a remote-control station for a follow-up.

3. DS as in claim 3 wherein the Decision-Making Function block predetermines and pre-configures a CDS decision based on internal thresholds and policies performing processes comprising:
using special skilled libraries to determine the level of threat, urgency, or the numbers of individuals involved in the potential crime;
causing to move the Security Robot towards the scene with its flashlight turned on to show its large police-like physical presence to intimidate and forewarn the suspect when the suspicious sequences match with that of a prior criminal scenario;
causing to move the Security Robot to initiate interactive conversations (i.e., in the Q&A style) with the suspect and the people nearby to collect further information if the suspect remains after the forewarning without leaving the scene;
asking the suspect what he or she is doing with a Security Robot's police-tone and in concise words;
ordering the suspect to leave the area or shooting red-ink water to drench the suspect, while the human guards are on the way to the scene If the suspect is determined to be an intruder; and
further adjusting the internal thresholds and policies based on local regulations and laws.

3. DS as in claim 3 wherein the Key Manager Function is configured to perform functions comprising:
(a) Collecting the robots with the same key as a collaborating group and allows the robots to communicate and share information;
(b) Segregating robots with different keys into non-communicating, non-sharing, and non-collaborating entities;
(c) Interacting with LLM and other functional blocks to define the crime and the associated tensor elements for knowledge learning;
(d) Enabling a robot with a specific key to learn a focused knowledge area deeply and quickly;
(e) Defining several crimes as a crime group and organizing the crimes as a “super tensor element” of the crime group;
(f) Authenticating the robots and preventing the attacked robot from participating in the crime detection;
(g) Monitoring each individual robot and revoking the key to disable an individual robot;
(h) Maintaining the lifecycle of the key including initiating, updating, revoking and transferring;
(i) Protecting the robotic system from attacks from quantum computers by running a set of post-quantum cryptography algorithms; and
(j) Protecting the robotic system from side-channel attacks by a set of algorithms and software policies.

3. DS as in claim 3 wherein the four functional blocks of CDS along with LLM are configured to provide major features of a robotics system comprising:
(a) Advanced environmental analysis and interpretation of nuance to identify potential security threats;
(b) Improved interaction with humans capable of engaging in complex and meaningful language conversations;
(c) Real-time decision making wherein the CDS would help Robots to make more informed decisions in real time;
(d) Language and speech recognition and communications wherein the LLM language model is configured to generate natural language, and capable of responding to suspicious persons with spoken commands;
(e) Customized responses in enabling Robots to talk in an authoritative tone using a clear and concise vocabulary without ambiguity;
(f) Crimes definition and categorization by software and keys such that each robot can be specialized in a specific mission and market segment; thus enabling a cost-effective robotic system to address a wide range of crimes.
(g) Crimes detection by a single robot or a group of collaborating robots organized by keys where complex crime may need different robots with different and complementary skills, which can be managed by the key manager while certain crimes may require robots in different geographic locations, which can also be managed by the CDS key manager; and
(h) Robot protection for robotics system from attacks wherein the key manager functional block protects each individual robot from attacks by quantum computers (and classical computers) by running post quantum cryptography algorithms while the key manager also protects each robot from side-channel attacks, achieving the highest security level for the post quantum era.
